(19) United States
(12) Patent Application Publication
(10) Pub. No.: US 2026/0113496 A1
(43) Pub. Date: Apr. 23, 2026

(54) Bandwidth-Efficient Method, Server and System for Digital Display

(71) Applicant: JCDecaux SE, NEUILLY SUR SEINE (FR)

(72) Inventor: Simon LI, Cergy (FR)

(73) Assignee: JCDecaux SE, NEUILLY SUR SEINE (FR)

(21) Appl. No.: 19/358,722

(22) Filed: Oct. 15, 2025

(30) Foreign Application Priority Data
Oct. 17, 2024 (FR) 2411261

(51) Int. Cl. H04N 21/262; H04N 21/83

(52) U.S. Cl. CPC H04N 21/26258; H04N 21/83

(57) ABSTRACT

Method implemented by at least one server which controls the display of digital content items by digital display devices, comprising: a) generating playlists, each playlist being intended to be played by one or more of said digital display devices, the generation of a playlist according to a display campaign comprising: a2) calculating a minimum number of occurrences of playing each content item that allows compliance with the share of total playing time allocated to each content item; a3) reducing the number of occurrences of at least one content item; a4) inserting identifiers of digital content items to be played into the list; e) sending at least one of said playlists to one or more of said digital display devices for which at least one of said playlists is intended.

### TECHNICAL FIELD

This disclosure relates to methods, servers and systems for digital display, to digital display devices, and to digital display servers. More specifically, this disclosure relates to bandwidth optimization in such methods, servers and systems.

### PRIOR ART

Methods, servers, and systems for digital display are known which allow deploying playlists and content items to digital display devices.

For example, within a digital display system, a server may send information to display devices indicating that a defined content item is to be displayed. Such a system allows the server to control the content item played by the devices, for example in order to correspond to display campaigns that are updated in real time.

For example, the server may send the display devices the content items to be played. Alternatively, the server may send the digital display devices one or more playlists containing identifiers of the content items to be played.

However, the data exchanged between the server and the display devices may be voluminous, which leads to significant bandwidth costs, particularly when it is likely that the content item will be frequently modified by the server.

One of the objectives of the present description is therefore to limit the amount of data exchanged between a server and display devices, within the framework of a display system in which the server indicates to the devices the content to be played.

### SUMMARY

The present description aims in particular to improve the efficiency of these methods.

To this end, a method is proposed, implemented by at least one server of control of the display of digital content items by digital display devices (2), comprising: a) generating playlists according to display campaigns, each playlist being intended to be played by one or more of said digital display devices, each playlist comprising at least one series of identifiers of digital content items to be played but not comprising addresses for loading the digital content items nor digital fingerprints of the digital content items, the generation of a playlist according to a display campaign comprising: a1) receiving a set of identifiers of digital content items to be played, each identifier being associated with a content item duration and a share of total playing time allocated to said content item in the display campaign; a2) calculating a minimum number of occurrences of playing each content item that allows compliance with the share of total playing time allocated to each content item in the playlist; a4) inserting identifiers of digital content items to be played, into the list; e) sending at least one of said playlists to one or more of said digital display devices (2) for which the at least one of said playlists is intended.

By means of these arrangements, the bandwidth usage for the communication to send the playlists between the server and the devices is reduced. Indeed, the data of the content item identifiers is more lean than that of the content item itself, or even of the content item fingerprints. In addition, the number of occurrences of content item identifiers is reduced, and the size of the list, and therefore the number of occurrences of identifiers to be inserted into the list, is reduced. The steps of the method therefore allow reducing the amount of data to be sent between the server and the devices, and therefore reducing the bandwidth requirements between the server and the devices, while taking into account the shares of total time allocated to each content item in the campaign.

According to another aspect, a digital display server is provided that is adapted to control digital display devices, said server being adapted to implement all or part of a method as defined herein.

According to another aspect, a computer program is provided comprising instructions for implementing all or part of a method as defined herein when this program is executed by a processor.

According to another aspect, a non-transitory computer-readable storage medium is provided on which such a program is stored.

The features set forth in the following paragraphs may optionally be implemented, independently of one another or in combination with one another:

In one embodiment, the method comprises: a3) reducing the number of occurrences of at least one content item; each identifier of a digital content item is inserted according to the reduced number of occurrences of said content item.

This allows further reducing the number of occurrences, and therefore the size of the list, while maintaining a reasonable approximation of the shares of total playing time respectively allocated to each content item.

In one embodiment, the method comprises: a5) checking whether the playlist meets at least one criterion selected from a list comprising a playlist duration criterion and a playlist size criterion, and, if the playlist meets said at least one criterion, each identifier of a digital content item is inserted into the list according to the minimum number of occurrences of each content item that allows compliance with the share of total playing time allocated to each content item; otherwise the method comprises: a3) reducing the number of occurrences of at least one content item; each identifier of a digital content item is inserted into the list according to the reduced number of occurrences of said content item.

This allows sending a list which strictly complies with the total playing times respectively allocated to each content item if the list is considered sufficiently lean, otherwise a list of reduced size but providing an acceptable approximation of the shares of total playing time allocated to each content item is sent.

In one embodiment, the content item identifiers are distributed by programs, and each content item identifier is associated with a share of playing time allocated to the content item within the program; each program is associated with a share of total playing time allocated to the program.

These features allow the share of time allocated to each content item to be defined in a flexible manner, both within a given program and overall, based on the share of total time allocated to each program.

In one embodiment, calculating a minimum number of occurrences of playing each content item that allows compliance with the share of total playing time allocated to each content item in the playlist comprises, for each program: a21) determining a reference numerator of the program as the least common multiple of the numerators of the shares of playing time allocated to the content items within the program; a22) expressing the shares of playing time allocated to the content items within the program in such a way that the numerator of each share of playing time allocated to a content item within the program is equal to said reference numerator of the program; a23) calculating a minimum duration of the program that allows compliance with the share of total playing time allocated to each content item within the program, as: the least common multiple of the denominators of the shares of playing time allocated to the content items within the program multiplied by the durations of the content items; dividing the result by the reference numerator of the program; a24) calculating a minimum number of occurrences of playing each content item of the program that allows compliance with the share of playing time allocated to the content item within the program, as: the minimum duration of the program that allows compliance with the share of total playing time allocated to each content item within the program, multiplied by the reference numerator of the program; dividing the result by the denominator of the share of playing time allocated to the content item within the program multiplied by the duration of the content item.

These features make it possible to define the minimum playing time, and the minimum number of occurrences of playing each content item that allows compliance with the share of total playing time allocated to each content item within each program.

In one embodiment, calculating a minimum number of occurrences of playing each content item that allows compliance with the share of total playing time allocated to each content item in the playlist then comprises: a25) defining a total duration multiplier coefficient, as the least common multiple of the numerators of the shares of playing time allocated to the programs; a26) expressing the shares of playing time allocated to the programs such that the numerator of each share of total playing time allocated to the program is equal to said total duration multiplier coefficient; a27) calculating a minimum total playing duration of the playlist that allows compliance with the share of total playing time allocated to each program, as: the least common multiple of the denominators of the shares of total playing time allocated to the programs multiplied by the minimum program durations that allow compliance with the share of total playing time allocated to each content item within the programs; dividing the result by the total duration multiplier coefficient; a28) calculating a minimum number of occurrences of playing each program that allows compliance with the share of playing time allocated to the program, as: the minimum total playing duration of the playlist that allows compliance with the share of total playing time allocated to each content item, multiplied by the total duration multiplier coefficient; dividing the result by the denominator of the share of total playing time allocated to the program multiplied by the minimum program duration that allows compliance with the share of total playing time allocated to each content item within the program.

These features make it possible to define the optimal playing time, meaning a minimum playing time for all content items that allows compliance with the share of total playing time allocated to each content item within each program, and the minimum number of occurrences of playing each program that allows compliance with the share of total playing time allocated to each content item.

In one embodiment, a3) reducing the number of occurrences of at least one content item comprises dividing the total number of occurrences of each content item by a same divisor, while approximating the total number of occurrences of content items that are not divisible by the divisor.

This allows reducing the total number of occurrences and the duration of the playlist, while maintaining a good approximation of the shares of playing time allocated to each content item.

In one embodiment, the step of reducing the number of occurrences of at least one content item is implemented only if a set of conditions is met, said set of conditions comprising at least one of the following conditions: the sum of the minimum number of occurrences of each content item that allows compliance with the share of total playing time allocated to each content item is greater than a threshold number of occurrences; the minimum duration of the list that allows compliance with the share of total playing time allocated to each content item is greater than a threshold duration.

These features allow the use of a so-called optimal pattern in which the numbers of occurrences of the content items allow strict compliance with the share of total playing time allocated to each content item in the case where the list is sufficiently lean and/or short (i.e. in cases where the playlist is already considered sufficiently lean without approximating the shares of playing times), and otherwise to reduce the number of occurrences of content item identifiers in the list.

In one embodiment, a3) reducing the number of occurrences of at least one content item comprises: deleting at least one of the programs in order to meet said set of conditions; calculating a minimum number of occurrences of playing each content item that allows compliance with the share of total playing time allocated to each content item without taking into account the at least one deleted program; determining a divisor of the duration of the playlist thus obtained; replacing said at least one of the deleted programs with an approximation of the division of the total number of occurrences of the program's content items by the divisor.

These features allow the size and duration of the list to be divided by a given divisor while obtaining an approximation that is as accurate as possible, since the division of the number of occurrences is accurate for at least one program.

In one embodiment, a3) reducing the number of occurrences of at least one content item comprises iteratively incrementing or decrementing the total counts of the content items, from longest to shortest content item, in order to reduce a remainder of a Euclidean division of the total counts of the content items by a divisor.

These features allow the number of occurrences to be divided by a given divisor even if some of the numbers of occurrences are not divisible by the divisor, while maintaining a good approximation of the relative playing times of the content items.

### BRIEF DESCRIPTION OF DRAWINGS

Other features, details and advantages will become apparent from reading the detailed description below, and from analyzing the attached drawings, in which:

FIG. 1 is a schematic view showing a digital display system according to one embodiment.

FIG. 2 is a schematic view showing a digital display system according to another embodiment.

FIG. 3 represents a method P3 implemented by at least one server according to one embodiment.

### MORE DETAILED DESCRIPTION

In the various figures, the same references designate identical or similar elements.

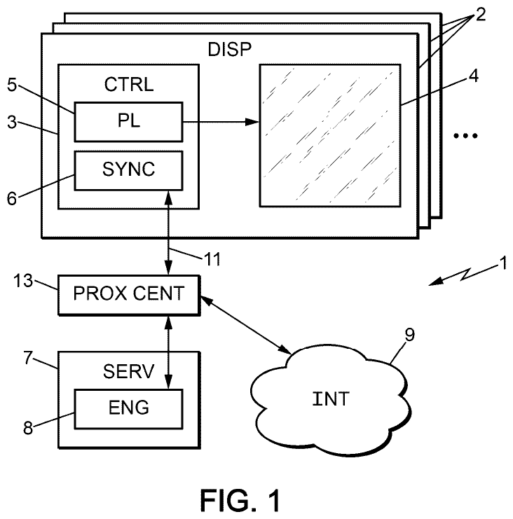

FIG. 1 shows a digital display system 1 comprising at least one server 7 (SERV) and some digital display devices 2 (DISP). For clarity in the presentation, the following description refers to one server 7, but the functions of the server 7 described below could be distributed across several servers 7.

Each display device 2 comprises a control device 3 (CTRL), such as a microcomputer or the like, which controls a digital screen 4.

The control device 3 runs a digital content player 5 (PL) (software module run by the control device 3) and also runs a synchronization module (software) 6 (SYNC).

The server 7 in particular runs an engine 8 (ENG) for generating lists of content items and loading manifests.

The synchronization module 6 of each digital display device 2 communicates with the server 7 and, if applicable, with other resources possibly on the Internet 9 (INT). In the embodiment shown, the digital display devices 2 communicate with the server(s) 7 and with said other resources via a central proxy server 13 (PROX CENT).

This communication may be carried out via any wide area network (WAN-links 11 in FIG. 1). For example, in many cases this communication is carried out via a mobile telephone network (broadband cellular network, for example 3G, 4G, or 5G). Of course, any other mode of communication is possible.

The engine 8 of the server 7 is adapted to generate playlists, repetitively and/or according to certain triggering events (changes in programming, content, etc.), (a) based on display campaigns. This generation of playlists is carried out based on the reservations made by advertisers for the various display devices 2, the digital content items to be played for these display campaigns, and the digital display devices available.

Each playlist is intended to be played by one or more of said digital display devices.

Each playlist comprises at least one series of identifiers of digital content items to be played sequentially over one or more predetermined time periods.

The playlist does not comprise addresses for loading the digital content items or digital fingerprints of the digital content items; it is therefore a document representing a low volume of data, since the identifiers of each digital content item have a smaller volume of data than the content item itself.

The engine 8 of the server 7 may also be adapted to generate for each display device, repetitively and/or according to certain triggering events (changes in programming, content, etc.), a loading manifest (b) comprising at least the loading addresses of the digital content items referenced in the loading list. Each loading manifest may further comprise, for each digital content item, the identifier included in the playlist.

Each loading manifest may further comprise at least one reference digital fingerprint for each digital content item referenced in said loading manifest. In one example, the digital fingerprint may be a checksum, for example of the “MD5” type. In another example, the digital fingerprint may be a digital signature of the “GPG” type. In a third example, the loading manifest may further comprise two reference digital fingerprints for each digital content item, in particular a checksum, for example a “MD5” checksum, and a more complex digital signature, for example a “GPG” digital signature.

The frequency at which playlists and loading manifests are generated by the engine 8 may vary depending on the speed at which new reservations or reservation modifications arrive from advertisers. This frequency may be as often as once every few minutes or even higher, knowing that some reservations may be made by automatic online auctions. As explained above, some playlist updates are made without changing the loading manifest, for example when the modifications concern the playback order or frequency of digital content items, or the conditions for playing digital content items.

The synchronization modules 6 of the digital display devices 2 may be adapted to update their playlists and loading manifests (c), based on the engine 8 of the server 7.

This update may comprise the following steps:
c1) The synchronization module 6 of the display device 2 polls the engine 8 of the server 7 by sending a request at predetermined intervals, in order to determine whether the server 7 has a new playlist and/or a new loading manifest corresponding to the digital display device 2. The engine 8 may be polled at a fixed frequency (for example every few minutes) or the frequency may be determined by a playlist and/or a loading manifest previously downloaded from the engine 8. For example, the frequency at which the engine 8 is polled for playlists may be fixed (for example every few minutes, in particular every 5 minutes) and the frequency at which the engine 8 is polled for loading manifests may be included in the playlists. The playlists and loading manifests may be timestamped, and in order to determine whether the server 7 has a new playlist corresponding to the digital display device 2, the synchronization module 6 may send a request to the engine 8 to receive the timestamp of the current playlist for the digital display device 2. If this timestamp is more recent than the timestamp of the last playlist downloaded by the digital display device 2, then it is determined that the engine 8 of the server 7 has a new playlist corresponding to the digital display device 2. The same procedure is followed for the loading manifests.

c2) If it is determined that the engine 8 has a new playlist corresponding to the digital display device 2 and/or a new loading manifest, the synchronization module loads the new playlist and/or the new loading manifest from the engine 8 of the server 7 (by sending a request to receive the new playlist and/or the new loading manifest).

c3) If a new loading manifest has been loaded from the server 7, the synchronization module 6 of the digital display device 2 determines which new digital content item(s) are referenced in the new loading manifest. This determination may be made, for example, by comparing the digital fingerprints of the digital content item(s) referenced in the new loading manifest with the digital fingerprints of the digital content item(s) already present in the memory of the digital display device 2.

c4) The synchronization module 6 of the digital display device 2 then downloads said new digital content item(s) from the URL(s) corresponding to each digital content item(s) indicated in the new loading manifest. Generally, this download is done via the Internet 9. The URL(s) in question may correspond to the server 7, to another server belonging to the operator of the server 7, or to another location on the Internet.

The player 5 of each digital display device 2 is adapted to read the digital content items corresponding to its current playlist (last playlist loaded by the synchronization module 6) and to display these digital content items on the digital screen 4 of the digital display device 2.

In steps (c1) and (c2), the synchronization module 6 of each digital display device 2 always sends its requests to the same URL address, which is specific to the digital display device 2.

In steps (c1) and (c2), the synchronization module 6 and the engine 8 of the server 7 may advantageously communicate in an encrypted manner, for example using the “https” protocol.

In step (c4), the synchronization module 6 of the digital display device 2 determines a calculated digital fingerprint of the newly downloaded digital content item, checks whether the calculated digital fingerprint matches the reference digital fingerprint contained in the loading manifest, and accepts the downloaded digital content item only if the calculated digital fingerprint matches the reference digital fingerprint. If the downloaded digital content item is not accepted, it is destroyed. If the loading manifest contains two (or more) digital fingerprints for at least some of the digital content items, this verification may be performed sequentially or in parallel for the various digital fingerprints of the digital content item.

In step (c4), the synchronization module 6 of the digital display device 2 may download the new digital content item in an unencrypted manner, for example using the “http” protocol.

In step (c4), the synchronization module 6 of the digital display device 2 may, in one embodiment, download the new digital content item in chunks.

The embodiment shown in FIG. 1 is provided only as a non-limiting example.

For example, in the example shown in FIG. 1, the display devices regularly poll the server to determine the existence of a new playlist. Alternatively, the server may directly send the playlists as soon as they become available. In all cases, the server generates playlists and sends them to the display devices, whether at the request of the devices or at its own initiative.

Similarly, the invention is not restricted to embodiments in which a manifest file is established. For example, the content item identifiers may refer to content item identifiers defined in a library accessible to the display devices, without requiring the use of manifest files.

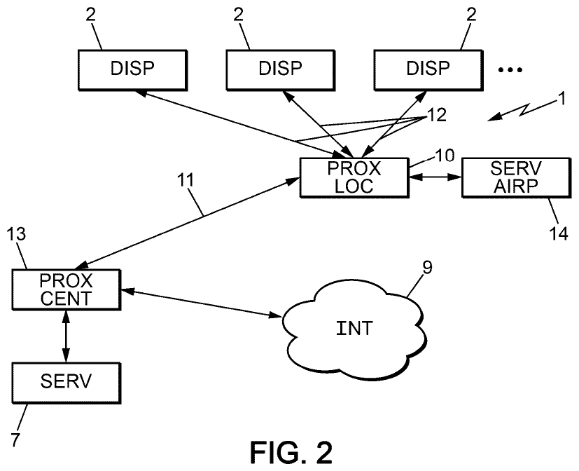

The embodiment shown in FIG. 2 is similar to that of FIG. 1 and will therefore not be described again in detail. This embodiment of FIG. 2 differs from that of FIG. 1 in that several of the digital display devices 2 belong to a local area network (link 12) which also comprises a proxy server 10 (PROX LOC) for content items, and the synchronization module of each digital display device 2 of the local area network is adapted to download the new digital content item through said proxy server 10. The proxy server 10 thus only loads each new content item once via link 11 which may possibly be of relatively low speed or relatively low quality, then distributes this content item to the different digital display devices 2 of the local area network via the higher speed and/or better quality links 12 of the local area network. The proxy server 10 may possibly also communicate with a local server 14 (SERV AIRP), for example one specific to an airport.

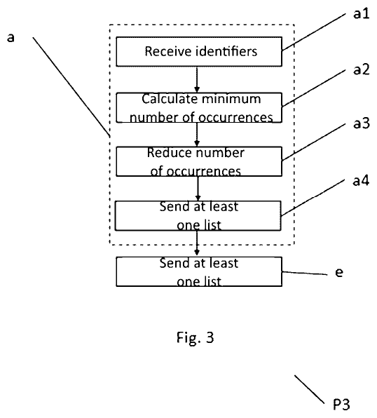

Reference is now made to FIG. 3.

FIG. 3 represents a method P3 implemented by at least one server, such as the server 7.

The objective of the method P3 is to generate playlists that can be sent to the display devices, while reducing the bandwidth consumption involved in sending the lists.

The method P3 comprises a first step a of generating playlists according to display campaigns, each playlist being intended to be played by one or more of said digital display devices, each playlist comprising at least one series of identifiers of digital content items to be played but not comprising addresses for loading the digital content items nor digital fingerprints of the digital content items.

The method P3 then comprises a second step of sending at least one of said playlists to one or more of said digital display devices (2) for which the at least one of said playlists is intended.

As indicated above, the lists may be generated according to different triggering events such as, for example, a programming modification or the occurrence of a new display campaign, and the playlists may be sent to the devices either at the initiative of the server or at the initiative of the devices.

In practice, a generated playlist is presented as a list of identifiers of digital content items. The content items corresponding to the identifiers can thus be played by the digital display devices, in the order in which the identifiers are listed. The digital display devices may restart playing the list from the beginning when all content items in the list have been played. The same identifier may appear multiple times in the list if the content item is to be played multiple times.

A playlist may be generated based on a given display campaign. A display campaign corresponds to the desired displaying of a set of content items on one or more display devices. A campaign may, for example, be an advertising campaign during which advertisements are displayed on the display devices, or a safety campaign during which safety content is displayed on the devices.

A campaign thus defines the content items to be displayed, but also a share of total playing time allocated to each content item. For example, a campaign may consist of displaying three content items: c₁, c₂ and c₃, with total shares of playing time of 1/10, 2/10, and 7/10, respectively.

The playlist must therefore be defined so that the actual playing times of each content item correspond to, or are close to, the shares of total playing time defined for the campaign.

However, strict adherence to the shares of playing time may result in a high number of occurrences of each identifier within the list, which increases the amount of data to be sent.

One aim of the invention is therefore to limit the amount of data to be sent from the server to the display devices, either by providing a calculated list of minimal size corresponding to the exact shares of time calculated, or by providing an acceptable approximation of the total playing times defined for the campaign. To this end, step a) of generating the list comprises four several substeps a1), a2, and a4), as well as optional steps a5 and a3 described below.

In a first substep a1), a set of identifiers of digital content items to be played is received. Each identifier is associated with a content item duration, corresponding to the duration of the content item targeted by the identifier.

Each identifier is also associated with a share of total playing time allocated to said content item in the display campaign. This share corresponds to the share of total playing time that is to be allocated to the content item targeted by the sample. A share of playing time may also be referred to as a “Share Of Time,” abbreviated as “SOT”.

The share of time allocated to a content item may be defined in several ways. For example, a share of total playing time may be allocated directly to each content item.

Alternatively, content item identifiers may be distributed across different programs (or campaigns), and:
Each identifier of a content item within a program may be associated with a share of playing time for the content item within the program.
Each program is associated with a share of total playing time for the programs.

In the remainder of this application, we will use the terminology defined below, as a non-limiting example:
the set of campaigns (or programs) related to a playlist will be denoted S;
the campaigns (or programs) related to a playlist are identified with an index i and denoted s₁, s₂ . . . sᵢ ∈S;
the playing duration of the program sᵢ will be denoted dₛ_{ᵢ}, and may for example be expressed in seconds, with dₛ_{ᵢ}∈N⁺ (strictly positive integer);
the share of playing time allocated to the program sᵢ will be denoted SOTₛ_{ᵢ}, with SOTₛ_{ᵢ} ∈R⁺⁺ (strictly positive relative number);
the set of content items related to a playlist will be denoted C, it being understood that each content item may be associated with a given program;
the content items related to a playlist are identified with two indices i and j, the content item c_{i,j} being content item j of program i;
the number of occurrences of the content item c_{i,j} in the playlist will be denoted λ_{c}_{_{i,j}};
the share of playing time for the content item c_{i,j} within the program sᵢ in the playlist will be denoted W_{c}_{_{i,j}}, with W_{c}_{_{i,j}}∈[0; 1]. This share of playing time will be expressed as a division of a numerator a_{c}_{_{i,j}} by a denominator b_{c}_{_{i,j}}, i.e.

$${W}_{{c}_{i , j}} = \frac{{a}_{{c}_{i , j}}}{{b}_{{c}_{i , j}}} ;$$

the duration of the content item j of the program i will be denoted d_{c}_{_{i,j}}.

The method P3 will thus be illustrated by an example in which three programs s₁, s₂ and s₃ are defined, each of the programs comprising three content items, defined respectively by the identifiers c_{1,1}, c_{1,2} and c_{1,3} for the content items of the program s₁; c_{2,1}, c_{2,2} and c_{2,3} for the content items of the program s₂; and c_{3,1}, c_{3,2} and c_{3,3} for the content items of the program s₃.

The content items may be strictly different between programs, or redundancies may exist. For example, the content items c1,1, c_{1,2}, c_{1,3}, c_{2,1}, c_{2,2} and c_{2,3}, c_{3,1}, c_{3,2} and c_{3,3} may be nine content items which are strictly different from each other, or some content items may be identical across programs. For example, the content items c_{1,1} and c_{2,3} may be the same. Different identical pairs, or more generally identical content items, may be identified across programs.

The shares of time allocated to the different programs and content items are summarized in the tables below. In the examples below, the durations of the content items are expressed in seconds.

The program s₁ in the example is associated with a share of total playing time SOT₁=⅔, and the durations and shares of total playing time for the content items within the program are listed for each content item in the table below.

TABLE 1

| Content item | | Share of playing time |
|---|---|---|
| identifier | Duration | within program s₁ |
| c_{1, 1} | 6 | ⅔ |
| c_{1, 2} | 10 | ⅙ |
| c_{1, 3} | 15 | ⅙ |

The program s₂ of the example is associated with a share of total playing time SOT₂=¼, and the durations and shares of total playing time for the content items within the program are listed for each content item in the table below.

TABLE 2

| Content item | | Share of playing time |
|---|---|---|
| identifier | Duration | within program s₂ |
| c_{2, 1} | 8 | ⅓ |
| c_{2, 2} | 10 | ⅓ |
| c_{2, 3} | 20 | ⅓ |

The program s₃ of the example is associated with a share of total playing time SOT₃= 1/12, and the durations and shares of total playing time for the content items within the program are listed for each content item in the table below.

TABLE 3

| Content item | | Share of playing time |
|---|---|---|
| identifier | Duration | within program s₃ |
| c_{3, 1} | 30 | ½ |
| c_{3, 2} | 15 | ¼ |
| c_{3, 3} | 12 | ¼ |

In this example, we can therefore note that:
the content items of programs s₁, s₂ and s₃ will be respectively played for ⅔, ¼, and 1/12 of the total playing time;
the content items c_{1,1}, c_{1,2} and c_{1,3} will be respectively played for ⅔, ⅙, and ⅙ of the playing time for program s₁;
the content items c_{2,1}, c_{2,2} and c_{2,3} will be respectively played for ⅔, ⅙, and ⅙ of the playing time for program s₂;
the content items c_{3,1}, c_{3,2} and c_{3,3} will be respectively played for ⅔, ⅙, and ⅙ of the playing time for program s₃;
from this we can deduce the share of total playing time allocated to each content item. For example, the share of total playing time allocated to content item c_{3,1} is thus ½*SOT₃=½ * 1/12= 1/24.

A second substep a2) consists of calculating a minimum number of occurrences of playing each content item that allows compliance with the share of total playing time allocated to each content item.

Indeed, the combinations of shares of playing time and durations of content items imply that compliance with the shares of total playing time can only occur for a given minimum number of occurrences of playing.

This minimum number of occurrences may be calculated in different ways.

For example, when the content items are distributed per program, we can first obtain for each program sᵢ:
a minimum program duration dₛ_{ᵢ}:
a division multiplier

$${a}_{{w}_{{c}_{i}}}$$

equal to the least common multiple of the numerators of the shares of playing time for the content items within the program;
a minimum number of occurrences of playing each content item within the playlist/c, that allows compliance with the share of playing time allocated to each content item within the program.

For example, in the case of the program s₁:
the minimum duration of the program will be denoted dₛ_{₁};
the minimum number of occurrences of playing the content items c_{1,1}, c_{1,2} and c_{1,3} within the playlist that allows compliance with the share of playing time allocated to each content item within the program s₁ will be respectively denoted λ_{c}_{_{1,1}}, λ_{c}_{_{1,2}} and λ_{c}_{_{1,3}}

The minimum number of occurrences that allows compliance with the share of playing time for each content item may be calculated for each program by first determining the minimum playing duration of each program. For example, substeps a21 to a24 described below may be implemented for each program for this purpose.

Using the notations defined above, one may note that the total playing duration of a content item within the playlist is equal to:
on the one hand, the duration of the content item multiplied by the number of occurrences of playing the content item, i.e. λ_{c}_{_{i,j}}*λ_{i,j};
and on the other hand, the share of playing time for the content item within the program multiplied by the playing duration of the program, i.e. W_{c}_{_{i,j}}*dₛ_{ᵢ}

From this, one can therefore deduce that, for all content items c_{i,j}:

$${d}_{{c}_{i , j}} * {λ}_{i , j} = {W}_{{c}_{i , j}} * {d}_{{s}_{i}} = \frac{{a}_{{c}_{i , j}}}{{b}_{{c}_{i , j}}} * {d}_{{s}_{i}}$$

To reuse the example of programs s₁, s₂, and s₃, strict compliance with playing times within the programs, while taking into account the durations of the programs and the shares of playing time allocated to each program, implies that:

$${d}_{{c}_{1 , 1}} * {λ}_{{c}_{1 , 1}} = 6 * {λ}_{{c}_{1 , 1}} = \frac{{a}_{{c}_{1 , 1}}}{{b}_{{c}_{1 , 1}}} * {d}_{{s}_{1}} = 2 / 3 * {d}_{{s}_{1}} ;$$

$${d}_{{c}_{1 , 2}} * {λ}_{{c}_{1 , 2}} = 10 * {λ}_{{c}_{1 , 2}} = \frac{{a}_{{c}_{1 , 2}}}{{b}_{{c}_{1 , 2}}} * {d}_{{s}_{1}} = 1 / 6 * {d}_{{s}_{1}} ;$$

$${d}_{{c}_{1 , 3}} * {λ}_{{c}_{1 , 3}} = 15 * {λ}_{{c}_{1 , 3}} = \frac{{a}_{{c}_{1 , 3}}}{{b}_{{c}_{1 , 3}}} * {d}_{{s}_{1}} = 1 / 6 * {d}_{{s}_{1}} ;$$

$${d}_{{c}_{2 , 1}} * {λ}_{{c}_{2 , 1}} = 6 * {λ}_{{c}_{2 , 1}} = \frac{{a}_{{c}_{2 , 1}}}{{b}_{{c}_{2 , 1}}} * {d}_{{s}_{2}} = 1 / 3 * {d}_{{s}_{2}} ;$$

$${d}_{{c}_{2 , 2}} * {λ}_{{c}_{2 , 2}} = 10 * {λ}_{{c}_{2 , 2}} = \frac{{a}_{{c}_{2 , 2}}}{{b}_{{c}_{2 , 2}}} * {d}_{{s}_{2}} = 1 / 3 * {d}_{{s}_{2}} ;$$

$${d}_{{c}_{2 , 3}} * {λ}_{{c}_{2 , 3}} = 15 * {λ}_{{c}_{2 , 3}} = \frac{{a}_{{c}_{2 , 3}}}{{b}_{{c}_{2 , 3}}} * {d}_{{s}_{2}} = 1 / 3 * {d}_{{s}_{2}} ;$$

$${d}_{{c}_{3 , 1}} * {λ}_{{c}_{3 , 1}} = 6 * {λ}_{{c}_{3 , 1}} = \frac{{a}_{{c}_{3 , 1}}}{{b}_{{c}_{3 , 1}}} * {d}_{{s}_{3}} = 1 / 2 * {d}_{{s}_{3}} ;$$

$${d}_{{c}_{3 , 2}} * {λ}_{{c}_{3 , 2}} = 10 * {λ}_{{c}_{3 , 2}} = \frac{{a}_{{c}_{3 , 2}}}{{b}_{{c}_{3 , 2}}} * {d}_{{s}_{3}} = 1 / 4 * {d}_{{s}_{3}} ;$$

$${d}_{{c}_{3 , 3}} * {λ}_{{c}_{3 , 3}} = 15 * {λ}_{{c}_{3 , 3}} = \frac{{a}_{{c}_{3 , 3}}}{{b}_{{c}_{3 , 3}}} * {d}_{{s}_{3}} = 1 / 4 * {d}_{{s}_{3}} .$$

A first substep a21 consists of defining a program reference numerator

$${a}_{{w}_{{c}_{i}}}$$

as the least common multiple of the numerators of the shares of playing time allocated to the content items within the program.

In the example of the program s₁, the numerators of the shares of playing time for the content items within the program are respectively 2, 1, and 1. Their least common multiple of the set of numerators, also called the program reference numerator and denote

$${a}_{{w}_{{c}_{1}}} ,$$

LCM (2, 1, 1)=2. The LCM( ) function represents the least common multiple of the arguments in parentheses. For the programs s₂ and s₃, the numerators are all equal to 1. We therefore have

$${a}_{{w}_{{c}_{2}}} = {a}_{{w}_{{c}_{3}}} = 1 .$$

A substep a22 may then consist of expressing the shares of playing time allocated to the content items within the program such that the numerator of each share of playing time allocated to a content item within the program is equal to said program reference numerator

$${a}_{{w}_{{c}_{i}}} .$$

In the example of the program s₁, with

$${a}_{{w}_{{c}_{1}}} = 2 ,$$

step a22 therefore consists of expressing the shares of playing time allocated to each content item such that their numerator is equal to 2. The equations governing the shares of playing time are then expressed as follows at the end of step a22:

$$6 * {λ}_{{c}_{1 , 1}} = 2 / 3 * {d}_{{s}_{1}} ;$$

$$10 * {λ}_{{c}_{1 , 2}} = 2 / 12 * {d}_{{s}_{1}} ;$$

$$15 * {λ}_{{c}_{1 , 3}} = 2 / 12 * {d}_{{s}_{1}} .$$

Then, a step a23 consists of calculating a minimum duration of each program that allows compliance with the share of total playing time allocated to each content item within the program, as:
the least common multiple of: the denominators

$${b}_{{w}_{{c}_{i , j}}}$$

of the shares of playing time allocated to the content items within the program multiplied by the durations d_{c}_{_{i,j}} of the content items; dividing the result by
the program reference numerator

$${a}_{{w}_{{c}_{i}}} .$$

Indeed, the equations governing the shares of playing time can be rewritten for all i,j as: b_{c}_{_{i,j}}*d_{c}_{_{i,j}}*λ_{c}_{_{i,j}}=a_{c}_{_{i,j}}*dₛ_{ᵢ}.

The solutions in N are such that:

$${a}_{{w}_{{c}_{i}}} * {d}_{{s}_{i}} = L C M ( {b}_{{w}_{{c}_{i , 1}}} * {d}_{{c}_{i , 1}} , {b}_{{w}_{{c}_{i , 2}}} * {d}_{{c}_{i , 2}} , … , {b}_{{w}_{{c}_{i , j}}} * {d}_{{c}_{i , j}} ) \qquad [ Math . 1 ]$$

Meaning that:

$${d}_{{s}_{i}} = \frac{L C M ( {b}_{{w}_{{c}_{i , 1}}} * {d}_{{c}_{i , 1}} , {b}_{{w}_{{c}_{i , 2}}} * {d}_{{c}_{i , 2}} , … , {b}_{{w}_{{c}_{i , j}}} * {d}_{{c}_{i , j}} )}{{a}_{{w}_{{c}_{i}}}} \qquad [ Math . 2 ]$$

In the example of the program s₁, equations governing the shares of playing time can therefore be rewritten in the following manner:

$$6 * 3 * {λ}_{{c}_{1 , 1}} = 2 * {d}_{{s}_{1}} ;$$

$$10 * 12 * {λ}_{{c}_{1 , 2}} = 2 * {d}_{{s}_{1}} ;$$

$$15 * 12 * {λ}_{{c}_{1 , 3}} = 2 * {d}_{{s}_{1}} .$$

The minimum duration of the program dₛ_{₁} that allows compliance with the share of total playing time allocated to each content item within the program is therefore such that:

$$2 * {d}_{{s}_{1}} = L C M ( 6 * 3 , 10 * 12 , 15 * 12 ) \qquad [ Math . 3 ]$$

Further meaning that:

$${d}_{{s}_{1}} = \frac{L C M ( 6 * 3 , 10 * 12 , 15 * 12 )}{2} = \frac{L C M ( 18 , 120 , 180 )}{2} = \frac{360}{2} = 180 \qquad [ Math . 4 ]$$

Finally, a step a24 consists of calculating a minimum number λ_{c}_{_{i,j}} of occurrences of playing each content item of the program that allows compliance with the share of playing time allocated to the content item within the program, as:
the minimum duration dₛ_{ᵢ} of the program that allows compliance with the share of total playing time allocated to each content item within the program, multiplied by the reference numerator

$${a}_{{w}_{{c}_{i}}} ;$$

dividing the result by
the denominator b_{w}_{_{ci,j}} of the share of playing time allocated to the content item within the program, multiplied by the duration of the content item d_{c}_{_{i,j}}.

Meaning that:

$${λ}_{{c}_{i , j}} = \frac{{a}_{{w}_{{c}_{i}}} * {d}_{{s}_{i}}}{{b}_{{w}_{{c}_{i , j}}} * {d}_{{c}_{i , j}}} \qquad [ Math 5 ]$$

In the case of the program s₁, we then have:

$${λ}_{{c}_{1 , 1}} = 2 * {d}_{{s}_{i}} / ( 6 * 3 ) = 2 * 180 / ( 6 * 3 ) = 20 ;$$

$${λ}_{{c}_{1 , 2}} = 2 * {d}_{{s}_{i}} / ( 10 * 12 ) = 2 * 180 / ( 10 * 12 ) = 3 ;$$

$${λ}_{{c}_{1 , 3}} = 2 * {d}_{{s}_{i}} / ( 15 * 12 ) = 2 * 180 / ( 15 * 12 ) = 2 .$$

After steps a21 to a24, we therefore know:
for each program, a minimum duration dₛ_{ᵢ} of the program that allows compliance with the share of total playing time allocated to each content item within the program (for example dₛ_{₁} for the program s₁); and
for each content item, a minimum number of occurrences λ_{c}_{_{i,j}} of playing the content item that allows compliance with the share of playing time allocated to the content item within the program (for example λ_{c}_{_{1,1}} for the content item c_{1,2}, and λ_{c}_{_{1,3}} for the content item c_{1,3}).

The calculations have been detailed above for the example of the program s₂. As the reader is now familiar with the proposed notations and calculations, the results will be provided directly for programs s₂ and s₃. The same calculations mentioned above but applied to program s₂ give:
a minimum duration of the program dₛ_{₂} that allows compliance with the share of total playing time allocated to each content item within the program=120s;
minimum number of occurrences of playing each content item of the program that allows compliance with the share of playing time allocated to the content item within the program λ_{c}_{_{2,1}}=5, λ_{c}_{_{2,2}}=4, and λ_{c}_{_{2,3}}=2.

The same calculations applied to the program s₃ give:
a minimum duration of the program dₛ_{₃} that allows compliance with the share of total playing time allocated to each content item within the program=240s;
minimum number of occurrences of playing each content item of the program that allows compliance with the share of playing time allocated to the content item within the program λ_{c}_{_{3,1}}=4, λ_{c}_{_{3,3}}=4, and λ_{c}_{_{3,3}}=5. In the hypothesis that a single program is used, the minimum number of occurrences of playing each content item that allows compliance with the share of total playing time allocated to each content item is then equal to the minimum number of occurrences of playing each content item of the program that allows compliance with the share of playing time allocated to the content item within a single program.

It should be noted that the presented order of steps a21 to a24 is not limiting, and that the steps may be executed in a different order, as long as the durations and the numbers of occurrences determined in steps a23 and a24 are not modified.

In other cases, where multiple programs are used, the minimum durations and the number of occurrences still need to be defined between the programs. In this case, the steps a25 to a28 described below may be implemented.

These steps will be illustrated using the example of the programs s₁, s₂ and s₃, in which the shares of total playing time allocated to each program are, respectively, SOT₁=⅔, SOT₂=¼, and SOT₃= 1/12.

The following data will be considered:
the shares of playing time allocated to each program i will be denoted SOTᵢ, or respectively SOT₁, SOT₂ and SOT₃ for the programs s₁, s₂ and s₃;
the minimum number of occurrences of playing each program i that allows compliance with the share of playing time allocated to the program are denoted SOCᵢ, respectively SOC₁, SOC₂ and SOC₃ for programs s₁, s₂ and s₃;
the minimum total playing duration that allows compliance with the share of total playing time allocated to each program is denoted OPD. This duration will also be called “optimal duration”.

Compliance with the shares of total playing time allocated to each program implies that:

$${d}_{{s}_{1}} * {SOC}_{1} = {SOT}_{1} * OPD ;$$

$${d}_{{s}_{2}} * {SOC}_{2} = {SOT}_{2} * OPD ;$$

$${d}_{{s}_{3}} * {SOC}_{3} = {SOT}_{3} * OP D .$$

Meaning that, with the known shares for SOT₁, SOT₂ and SOT₃:

$${d}_{{s}_{1}} * {SOC}_{1} = 2 / 3 * OPD ;$$

$${d}_{{s}_{2}} * {SOC}_{2} = 1 / 4 * OPD ;$$

$${d}_{{s}_{3}} * {SOC}_{3} = 1 / 12 * OPD .$$

In step a25, a total duration multiplier coefficient is defined as the least common multiple of the numerators of the shares of playing time allocated to the programs.

In the example, this multiplier coefficient is therefore equal to LCM (2, 1, 1)=2.

In a step a26, the shares of playing time allocated to the programs are expressed in such a way that the numerator of each share of total playing time allocated to the program is equal to said total duration multiplier coefficient. In the example, we then obtain:

$${d}_{{s}_{1}} * {SOC}_{1} = 2 / 3 * OPD ;$$

$${d}_{{s}_{2}} * {SOC}_{2} = 2 / 8 * OPD ;$$

$${d}_{{s}_{3}} * {SOC}_{3} = 2 / 24 * OPD .$$

In step a27, a minimum total playing duration of the playlist OPD that allows compliance with the share of total playing time allocated to each program is calculated, as:
the least common multiple of: the denominators of the shares of total playing time allocated to the programs multiplied by the minimum durations of the programs that allow compliance with the share of total playing time allocated to each content item; dividing the result by
the total duration multiplier coefficient.

Indeed, the above equations can be rewritten as:

$$3 * {d}_{{s}_{1}} * {SOC}_{1} = 2 * OPD ;$$

$$8 * {d}_{{s}_{2}} * {SOC}_{2} = 2 * OPD ;$$

$$24 * {d}_{{s}_{3}} * {SOC}_{3} = 2 * OPD .$$

The minimum total playing duration that allows compliance with the share of total playing time allocated to each content item is therefore such that:

$$2 * OPD = LCM ( 3 * {d}_{{s}_{1}} , 8 * {d}_{{s}_{2}} , 24 * {d}_{{s}_{3}} ) \qquad [ Math . 3 ]$$

Further meaning that:

$$OPD = \frac{LCM ( 3 * 180 , 8 * 120 , 24 * 240 )}{2} = \frac{LCM ( 540 , 960 , 5760 )}{2} = \frac{17280}{2} = 180 \qquad [ Math . 4 ]$$

The optimal duration in this example is therefore 8640 seconds, or 2.4 h.

In a step a28, a minimum number of occurrences of playing each program that allows compliance with the share of playing time allocated to the program is calculated, as:
the minimum total playing duration of the playlist OPD that allows compliance with the share of total playing time allocated to each content item, multiplied by the total duration multiplier coefficient; dividing the result by
the denominator of the share of total playing time allocated to the program, multiplied by the minimum duration of the program that allows compliance with the share of total playing time allocated to each content item.

Indeed, the above equations can be rewritten:

$${SOC}_{1} = 2 * OPD / ( 3 * {d}_{{s}_{1}} )$$

$${SOC}_{2} = 2 * OPD / ( 8 * {d}_{{s}_{2}}$$

$${SOC}_{3} = 2 * OPD / ( {24}^{*} {d}_{{s}_{3}}$$

At this stage, we therefore know the minimum total playing duration OPD that allows compliance with the share of total playing time allocated to each program, as well as the minimum number of occurrences of playing each program that allows compliance with the share of playing time allocated to the program.

It is then possible to determine the minimum number of occurrences of playing each content item that allows compliance with the share of total playing time allocated to each content item in the playlist, as: the minimum number of occurrences Δ_{c}_{_{i,j}} of playing each content item in the program that allows compliance with the share of playing time allocated to the content item within the program, multiplied by the minimum number of occurrences SOCᵢ of playing each program that allows compliance with the share of playing time allocated to the program.

For example, for content item c_{1,1}, the minimum number of occurrences of playing c_{1,1} that allows compliance with the share of total playing time allocated to c_{1,1} within the playlist is equal to λ_{c}_{_{1,1}}*SOCᵢ=32*20=640.

Note that the minimum number of occurrences of playing each content item, as well as the optimal total playing duration, can be very high. Playlists that strictly comply with the shares of time allocated to each content item can therefore be very long. In the example, the identifier of the content item c_{1,1} would, for example, have to be repeated 640 times in the list. This can increase the size of the list to be sent, and the associated bandwidth requirements for sending it.

In the example of programs s₁, s₂ and s₃, the number of occurrences of each content item within a program and the total number of occurrences are thus respectively as follows:

TABLE 4

| | | | Minimum | | |
|---|---|---|---|---|---|
| | | Share of | number of | | |
| | | playing time | occurrences | | |
| Content item | | W_{c}_{_{1, j}} within | λ_{c}_{_{1, j}} within | Total number | |
| identifier | Duration | program s₁ | program s₁ | of occurrences | |
| c_{1, 1} | 6 | ⅔ | 20 | 640 | (=32*20) |
| c_{1, 2} | 10 | ⅙ | 3 | 96 | (=32*3) |
| c_{1, 3} | 15 | ⅙ | 2 | 64 | (=32*2) |

TABLE 5

| | | | Minimum | |
|---|---|---|---|---|
| | | Share of | number of | |
| | | playing time | occurrences | |
| Content item | | W_{c}_{_{2, j}} within | λ_{c}_{_{1, j}} within | Total number |
| identifier | Duration | program s₂ | program s₂ | of occurrences |
| c_{2, 1} | 8 | ⅓ | 5 | 90 |
| c_{2, 2} | 10 | ⅓ | 4 | 72 |
| c_{2, 3} | 20 | ⅓ | 2 | 36 |

TABLE 6

| | | | Minimum | |
|---|---|---|---|---|
| | | Share of | number of | |
| | | playing time | occurrences | |
| Content item | | W_{c}_{_{3, j}} within | λ_{c}_{_{3, j}} within | Total number |
| identifier | Duration | program s₃ | program s₃ | of occurrences |
| c_{3, 1} | 30 | ½ | 4 | 12 |
| c_{3, 2} | 15 | ¼ | 4 | 12 |
| c_{3, 3} | 12 | ¼ | 5 | 15 |

In order to reduce the bandwidth requirements for sending the data, a substep a3 of reducing the number of occurrences of at least one content item may be implemented.

In practice, this step consists of reducing the number of occurrences to be inserted into the list for at least one content item, while taking into account the minimum number of occurrences of each content item that allows compliance with the share of total playing time allocated to each content item, and/or the minimum duration of the list that allows compliance with the share of total playing time allocated to each content item.

In a set of embodiments described below, step a) comprises a substep a3 and/or a substep a5.

A substep a5 consists of verifying whether the playlist meets at least one criterion selected from a list comprising a playlist duration criterion and a playlist size criterion.

In other words, at least one criterion is met in step a5 if:
the list size is less than a threshold. The list size may for example consist of:
   a number of occurrences of content items in the list;
   or a size of the data storing the list, the size being expressed for example in bytes or kilobytes;
and/or the list duration, i.e. the sum of the durations of each up-to-date content item occurrence, is less than a threshold.

If at least one criterion is met in step a5, the list is therefore considered to be sufficiently lean and/or short, i.e. sending the list will mobilize a limited amount of network resources.

In the embodiment shown by way of non-limiting example in FIG. 3, if at least one criterion is met (i.e., if the playlist is considered to be sufficiently lean and/or short), a step a4 of sending the list is carried out. If, on the contrary, at least one criterion is not met (i.e. if the list is considered too long and/or too voluminous), a substep a3 of reducing the size of the list is carried out prior to the substep a4 of sending the list.

Substep a3 allows reducing the size of the list, and therefore the amount of data that is ultimately to be sent.

Step a3 may, for example, be implemented by dividing the total number of occurrences of each content item by a same divisor, approximating the total number of occurrences of content items that are not divisible by the divisor.

The divisor may be chosen arbitrarily, or so as to achieve a goal of reducing the number of occurrences/the duration of the track. The divisor may also be chosen so as to obtain an exact division of the largest possible number of content item identifiers. For example, in the case of programs s₁, s₂ and s₃, a division by 3 will allow an exact division of the number of content items of programs s₂ and s₃, and an approximate division of the number of content items of program s₁.

According to various embodiments of the invention, step a3 may be implemented systematically, or implemented only when certain conditions are met.

For example, step a3 of reducing the number of occurrences of at least one content item may be implemented only if a set of conditions including at least one of the following conditions is met:
the sum of the minimum number of occurrences of each content item that allows compliance with the share of total playing time allocated to each content item is greater than a threshold number of occurrences;
the minimum duration of the list that allows compliance with the share of total playing time allocated to each content item is greater than a threshold duration.

In other words, in this case, step a3 is only implemented if the total number of occurrences of identifiers to be inserted is greater than a threshold number of occurrences and/or the minimum duration of the list is greater than a threshold duration. The thresholds for the number of occurrences and/or for the duration may be defined in different ways. For example, they may be defined based on a play track size limit which allows sufficiently limiting the bandwidth used for sending the data, or a maximum duration of the play track which allows efficient loading into playback devices.

According to these embodiments, a list will therefore be considered sufficiently lean if it includes a sufficiently low number of occurrences of identifiers and/or a sufficiently short duration. In such case, the optimal pattern which allows strict compliance with the share of total playing time allocated to each content item will be used. Otherwise, step a3 will be triggered to reduce the size (in number of identifiers) and/or the duration of the playlist.

Various actions may be implemented as part of step a3. For example, in embodiments where the content item is distributed across several programs, and where step a3 is only implemented if a set of conditions is met, step a3 may comprise deleting at least one of the programs in order to meet said set of conditions.

Again using the example of programs s₁, s₂ and s₃ as defined above, let us consider a duration limit for the play track that is set at 1 hour.

At the end of step a2, the playback duration according to the optimal pattern, i.e. the minimum total playing duration that allows compliance with the share of total playing time allocated to each program, was calculated to be 2.4 hours, which is greater than the one-hour limit.

At least one of the programs may thus be deleted, and the minimum duration OPD recalculated without the at least one deleted program, in order to reduce the total minimum playback duration that allows compliance with the share of total playing time allocated to each program. Indeed, the deletion of one or more programs makes it possible to reduce the number of content items to be played, and therefore to simplify the combination of durations and the number of occurrences of content items that allows compliance with the shares of total playing time.

For example:
By removing s₁, and keeping only s₂ and s₃, the minimum duration OPD will be reduced to LCM(960, 5760)/2=2880s, or about 0.8h;
By removing s₂, and keeping only s₁ and s₃, the minimum duration OPD will be reduced to LCM(540, 5760)/2=8640s, or about 2.4h;
By removing s₃, and keeping only s₁ and s₂, the minimum duration OPD will be reduced to LCM(540, 960)/2=4320s, or about 1.2h.

We can therefore see here that deleting s₂ has no effect on the duration of the play track, deleting s₃ halves the duration, which is still insufficient to obtain a list of less than one hour, and finally deleting s₁ divides the duration by 3, which allows obtaining a list of approximately 0.8 hours, which is less than the one-hour limit. The deletion of s can therefore be retained in order to reduce the duration of the list. The same principle may be applied in order to reduce the number of occurrences of content item identifiers in the list. One or more programs may be deleted, according to different embodiments.

In the case where several deletions allow the defined conditions to be met, the solution closest to the limiting conditions (for example, the deletion allowing the longest duration while remaining below 1 hour) may be chosen.

If deleting a single program does not allow the defined conditions to be met, the deletion of two programs may be considered.

A divisor of the playlist duration thus obtained, without taking into account the deleted programs, may then be determined. In the example above, the duration of the play track was divided by 3 by deleting s₁. In practice, this division by 3 corresponds to an exact division made possible by deleting s₁, because the number of occurrences of the content items of s₁ were not divisible by 3, while those of s₂ and s₃ were.

Finally, the deleted program(s) may be replaced by an approximation of dividing the total numbers of occurrences of the program's content items, by the divisor.

Thus, the size and duration of the list can be divided by a given divisor, obtaining as exact an approximation as possible, since the division of the number of occurrences is exact for at least one program.

Again using the example of s₁, s₂ and s₃, the total number of occurrences can thus be divided by 3 by approximating the number of occurrences for s₁ only. For example, we may obtain the following results:

TABLE 7

| | | Share of | Number of | |
|---|---|---|---|---|
| | | playing time | occurrences | |
| Content item | | within | within | Total number |
| identifier | Duration | program s₁ | program s₁ | of occurrences |
| c_{1, 1} | 6 | ⅔ | 20 | 203 |
| c_{1, 2} | 10 | ⅙ | 3 | 34 |
| c_{1, 3} | 15 | ⅙ | 2 | 24 |

TABLE 8

| | | Share of | Number of | |
|---|---|---|---|---|
| | | playing time | occurrences | |
| Content item | | within | within | Total number |
| identifier | Duration | program s₂ | program s₂ | of occurrences |
| c_{2, 1} | 8 | ⅓ | 5 | 30 |
| c_{2, 2} | 10 | ⅓ | 4 | 24 |
| c_{2, 3} | 20 | ⅓ | 2 | 12 |

TABLE 9

| | | Share of | Number of | |
|---|---|---|---|---|
| | | playing time | occurrences | |
| Content item | | within | within | Total number |
| identifier | Duration | program s₃ | program s₃ | of occurrences |
| c_{3, 1} | 30 | ½ | 4 | 4 |
| c_{3, 2} | 15 | ¼ | 4 | 4 |
| c_{3, 3} | 12 | ¼ | 5 | 5 |

One will note that, for the content items of programs s₂ and s₃, the total number of occurrences indeed corresponds to an exact division by 3 of the number of occurrences in the optimal pattern, while for program s₁, this is an approximate division by 3.

The shares of time actually obtained for programs s₁, s₂ and s₃ are therefore 0.666435, 0.250173, and 0.0833941, very close to the allocated shares of ⅔, ¼, and 1/12 respectively.

This example demonstrates that the size and duration of the play track can be significantly reduced while maintaining a reasonable approximation of the shares of time allocated to each content item.

According to different embodiments, the approximation of the division of the total number of occurrences of the program's content items by the divisor may, in practice, be carried out in different ways.

In one set of embodiments, a3) reducing the number of occurrences of at least one content item comprises iteratively incrementing or decrementing the total counts of the content items, from longest to shortest content item, in order to reduce a remainder of a Euclidean division of the total counts of the content items by a divisor.

Some concrete examples of such divisions are given below.

### 1st Example of Division Approximation

Again using the example of programs s₁, s₂ and s₃, if the duration of the play track is recalculated by removing s₁, we obtain, on the basis of programs s₂ and s₃ alone, a playing duration that allows compliance with the shares of playing time allocated to the programs OPD=2880s; we then have:

$$For {s}_{2} : 960 * {SOC}_{2} = 2 * OPD , i . e . {SOC}_{2} = 6 ;$$

$$For {s}_{3} : 5760 * {SOC}_{3} = 2 * OPD , i . e . {SOC}_{3} = 1.$$

For s₁, we perform the Euclidean division of 2*OPD by 540:2*OPD=5760=540*10+360=3*(6*λ_{c}_{_{1,1}}+10*λ_{c}_{_{1,1}}+15*λ_{c}_{_{1,1}})*10+360=18*(λ_{c}_{_{1,1}}*10)+30*(λ_{c}_{_{1,2}}*10)+45*(λ_{c}_{_{1,3}}*10)+360=18*200+30*30+45*20+360.

In the equation 2*OPD=18*200+30*30+45*20+360, the terms occ1=200, occ2=30 and occ3=20 respectively represent the total number of occurrences of playing the content items c_{1,1}, c_{1,2} and c_{1,3} in the playlist.

We will then try to eliminate the remainder r=360 by progressively incrementing the occurrences of the content items c_{1,1}, c_{1,2} and c_{1,3}. To do this, we order the coefficients by decreasing order of the multiplier coefficient 45>30>18 corresponding to multiplying the durations of the content items by 3, i.e. we will first increment the number of occurrences occ3 of c_{1,3}, then occ2 of c_{1,2}, then occ1 of c_{1,1}, before iterating again by incrementing occ3 first.

In a first iteration, r=360>45, we then increment occ3 to reduce r: occ3=occ3+1=21, and r=r−45=315.

Then we move on to coefficient 30: r=315>30, we then increment occ2 to reduce r: occ2=occ2+1=31, and r=r−30=285.

And so on with coefficient 18, then starting again at 45 for a new iteration.

After several iterations of incrementations, we end with occ1=203, occ2=34, occ3=24, and r=6<18<30<45, and the iterations are therefore stopped.

We thus arrive at the solution shown in Tables 7 to 9.

### 2nd Example of Division Approximation

Again using the example of programs s₁, s₂ and s₃, if the duration of the play track is recalculated by removing s₁, we obtain, on the basis of programs s₂ and s₃ alone, a playing duration that allows compliance with the shares of playing time allocated to the programs, OPD=2880s; we then have:

$$For {s}_{2} : 960 * {SOC}_{2} = 2 * OPD , i . e . {SOC}_{2} = 6 ;$$

$$For {s}_{3} : 5760 * {SOC}_{3} = 2 * OPD , i . e . {SOC}_{3} = 1.$$

It is assumed here that 3*d1=6000>2*OPD.

We therefore have:

$$2 * OPD = 5760 = 6000 * 0 + 5760 ;$$

$$3 * d 1 = 3 * ( 6 * {λ}_{{c}_{1 , 1}} + 10 * {λ}_{{c}_{1 , 2}} + 15 * {λ}_{{c}_{1 , 3}} ) = 18 * {λ}_{{c}_{1 , 1}} + 30 * {λ}_{{c}_{1 , 2}} + 45 * {λ}_{{c}_{1 , 3}} .$$

In this example, occurrences are deleted in order to reduce the product of 3*d1 to 2*OPD=5760, meaning we will fill the box e=3*d1−2*OPD=6000−5760=240 with the entities 18, 30 and 45 while decrementing the number of occurrences.

We again order the coefficients in descending order 45>30>18, then we iteratively fill the 3 coefficients.

In a first iteration, e=240, then:
e>45, therefore e=e-45=195, and occ3--=19
e>30, therefore e=e-30=165, and occ2--=2;
etc.

After several iterations, we obtain λ_{c}_{_{1,1}}=17, λ_{c}_{_{1,2}}=1, λ_{c}_{_{1,3}}=0, and e=9. Because e<18<30<45, the iterations stop here and the approximation is obtained.

### 3rd Example of Division Approximation

In this example, we aim for a playlist duration limit L=2100s; and two programs are considered:

A program s₄, with a share of playing time SOT₄=⅓, is defined as:

TABLE 10

| Content item | | Share of playing time |
|---|---|---|
| identifier | Duration | W_{c}_{_{4, j}} within program s₄ |
| c_{4, 1} | 7 | ⅓ |
| c_{4, 2} | 10 | ⅓ |
| c_{4, 3} | 11 | ⅓ |

The minimum duration of s₄dₛ_{₄} that allows compliance with the share of total playing time allocated to each content item within program s₄ is therefore equal to: dₛ_{₄}=3*LCM(7,10,11)=3*7*10*11=3*770=2310 s>L.

A program s₅, with a share of playing time SOT₅=⅔, is defined as:

TABLE 11

| Content item | | Share of playing time |
|---|---|---|
| identifier | Duration | W_{c}_{_{5, j}} within program s₅ |
| c_{5, 1} | 7 | ⅓ |
| c_{5, 2} | 20 | ⅓ |
| c_{5, 3} | 11 | ⅓ |

The minimum duration of s₅, dₛ_{₅}, is therefore equal to: dₛ_{₅}=3*LCM(7,20,11)=3*7*20*11=3*1540=4620 s>L.

In the optimal pattern, s₄ is played once and s₅ once (respectively ⅓ and ⅔ of the allocated time, given that s₅ is twice as long as s₄); we therefore have a minimum duration that allows compliance with the shares of time allocated to all content items: OPD=2310+4620=6930 s.

To reduce the duration of the playlist to the limit L, we apply a divisor, or division coefficient: d=L/OPD=2100/6930.

We therefore obtain the following optimal and reduced numbers of occurrences:

TABLE 12

| | | Optimal | Reduced | Remainder = |
|---|---|---|---|---|
| Content item | | Number of | Number of | decimal * |
| identifier | Duration | Occurrences | Occurrences | duration |
| c_{4, 1} | 7 | 110 | 33.33333 | 2.33333 |
| c_{4, 2} | 10 | 77 | 23.33333 | 3.33333 |
| c_{4, 3} | 11 | 70 | 21.21212 | 2.33333 |
| Total of | | | | 8 |
| remainders | | | | |

A program s₅, with a share of playing time SOT₅=⅔, is defined as:

TABLE 13

| | | Optimal | Reduced | Remainder = |
|---|---|---|---|---|
| Content item | | Number of | Number of | decimal * |
| identifier | Duration | Occurrences | Occurrences | duration |
| c_{5, 1} | 7 | 220 | 66.66666 | 4.66666 |
| c_{5, 2} | 20 | 77 | 23.33333 | 6.66666 |
| c_{5, 3} | 11 | 140 | 42.42424 | 4.66666 |
| Total of | | | | 16 |
| remainders | | | | |

Within each program, we iteratively increment the occurrences, from the content item having the longest duration to the content item having the shortest duration, in order to reduce the remainder.

For s₄, we order the content items in the order of their durations 11>10>7.

We then have a remainder r=8<11, and r<10. Neither the number of occurrences of c_{4,2} nor the number of occurrences of c_{4,3} are therefore incremented.

On the other hand, since r<7, we therefore increment the number of occurrences of c_{4,1} and subtract 7 from the remainder: r=r−7=8−7=1. No further increments are possible, and we obtain the following final reduced occurrences:

TABLE 13

| | | Optimal | Reduced | Final Reduced |
|---|---|---|---|---|
| Content item | | Number of | Number of | Number of |
| identifier | Duration | Occurrences | Occurrences | Occurrences |
| c_{4, 1} | 7 | 110 | 33.33333 | 34 |
| c_{4, 2} | 10 | 77 | 23.33333 | 23 |
| c_{4, 3} | 11 | 70 | 21.21212 | 21 |

For s₅, we order the content items in the order of their durations 20>11>7.

We have a remainder r=16<20. The number of occurrences of c_{5,2} is therefore not incremented.

On the other hand, since r>11, we therefore increment the number of occurrences of c_{5,3}, and subtract 11 from the remainder: r=r−11=5. No further incrementing is possible since r=5<7<11<20, and we obtain the following final reduced occurrences:

TABLE 14

| | | Optimal | Reduced | Final Reduced |
|---|---|---|---|---|
| Content item | | Number of | Number of | Number of |
| identifier | Duration | Occurrences | Occurrences | Occurrences |
| c_{5, 1} | 7 | 220 | 66.666666 | 66 |
| c_{5, 2} | 20 | 77 | 23.33333 | 23 |
| c_{5, 3} | 11 | 140 | 42.42424 | 43 |

The final duration of the reduced pattern is equal to 34*7+23*10+21*11+66*7+23*20+43*11=2094 s<L (2100s).

The actual shares of time allocated to s₄ and s₅ are respectively 699/2094=0.33381, and 1395/2094=0.66618, very close to the shares of total playing time allocated to programs ⅓ and ⅔.

We can therefore see that the duration of the list and the number of occurrences of the content item identifiers are significantly reduced, while still providing a very good approximation of the shares of total playing time allocated to the programs and content items.

Returning to FIG. 3, step a) includes a substep a4) of inserting into the list the identifiers of the digital content items to be played.

In practice, step a4 consists of writing the content items of the list with the content item identifiers.

The occurrences of the identifiers may be inserted in different ways, as long as the number of occurrences of each content item is respected. For example, they may be inserted randomly, or by spacing apart the occurrences of a same content item as regularly as possible.

Each identifier of a digital content item may be inserted:
according to the reduced number of occurrences of the content item, if substep a3 has been executed;
according to the minimum number of occurrences of the content item which allows strict compliance with the respective shares of playing time for each content item, if substep a3 has not been executed.

At the end of step a4, the list can therefore be defined with:
the minimum number of occurrences of content items that allows strict compliance with the respective shares of playing time for each content item. In this case, the list sent is the shortest/most lean list that allows strict compliance with the respective playing times for each content item;
a reduced number of occurrences that provides a satisfactory approximation of the shares of time allocated to each content item. In this case, the playlist can therefore be sent with a bandwidth usage that is further reduced while still satisfactorily approximating the respective shares of playing time for each content item.

As indicated above, FIG. 3 is provided as a non-limiting example only of one embodiment of the invention. According to other embodiments of the invention, substeps a3 and/or a5 may not be implemented, and the structuring between substeps a3, a4 and a5 may be different. For example: neither of substeps a3 or a5 may be implemented. In this case, the playlist is systematically sent according to the minimum number of occurrences which allows strict compliance with the respective shares of playing time for each content item;
substep a3 may be implemented, but not substep a5. In this case, the substep a3 of reducing the size of the list is systematically implemented in order to reduce the size of the list, in particular by maintaining an acceptable approximation of the respective shares of playing time for the content items;
substep a5 may be implemented, but not substep a3. In this case, the playlist is sent only if at least one criterion is met in substep a5.

This disclosure is not limited to the examples for the method, system, and supervised machine learning engine described above solely by way of example, but encompasses all variants conceivable to a person skilled in the art, within the framework of the protection sought.

1. A Method implemented by at least one server of control of the display of digital content items by digital display devices, comprising:
a) generating playlists according to display campaigns, each playlist being intended to be played by one or more of said digital display devices, each playlist comprising at least one series of identifiers of digital content items to be played but not comprising addresses for loading the digital content items nor digital fingerprints of the digital content items, the generation of a playlist according to a display campaign comprising:
a1) receiving a set of identifiers of digital content items to be played, each identifier being associated with a content item duration and a share of total playing time allocated to said content item in the display campaign;
a2) calculating a minimum number of occurrences of playing each content item that allows compliance with the share of total playing time allocated to each content item in the playlist;
a4) inserting the identifiers of digital content items to be played, into the list;
e) sending at least one of said playlists to one or more of said digital display devices for which at least one of said playlists is intended.

2. The method according to claim 1:
comprising a3) reducing the number of occurrences of at least one content item;
wherein each identifier of a digital content item is inserted according to the reduced number of occurrences of said content item.

3. The method according to claim 1, comprising a5) checking whether the playlist meets at least one criterion selected from a list comprising a playlist duration criterion and a playlist size criterion, and:
if the playlist meets the at least one criterion, each identifier of a digital content item is inserted into the list according to the minimum number of occurrences of each content item that allows compliance with the share of total playing time allocated to each content item;
otherwise:
the method comprises a3) reducing the number of occurrences of at least one content item;
each identifier of a digital content item is inserted into the list according to the reduced number of occurrences of said content item.

4. The method according to claim 1, wherein the content item identifiers are distributed by programs, and:
each content item identifier is associated with a share of playing time allocated to the content item within the program;
each program is associated with a share of total playing time allocated to the program.

5. The method according to claim 4, wherein calculating a minimum number of occurrences of playing each content item that allows compliance with the share of total playing time allocated to each content item in the playlist comprises, for each program:
a21) determining a reference numerator of the program as the least common multiple of the numerators of the shares of playing time allocated to the content items within the program;
a22) expressing the shares of playing time allocated to the content items within the program in such a way that the numerator of each share of playing time allocated to a content item within the program is equal to said reference numerator of the program;
a23) calculating a minimum duration of the program that allows compliance with the share of total playing time allocated to each content item within the program, as:
the least common multiple of the denominators of the shares of playing time allocated to the content items within the program multiplied by the durations of the content items; dividing the result by
the reference numerator of the program;
a24) calculating a minimum number of occurrences of playing each content item of the program that allows compliance with the share of playing time allocated to the content item within the program, as:
the minimum duration of the program that allows compliance with the share of total playing time allocated to each content item within the program, multiplied by the reference numerator of the program; dividing the result by
the denominator of the share of playing time allocated to the content item within the program multiplied by the duration of the content item.

6. The method according to claim 5, wherein calculating a minimum number of occurrences of playing each content item that allows compliance with the share of total playing time allocated to each content item in the playlist then comprises:
a25) defining a total duration multiplier coefficient, as the least common multiple of the numerators of the shares of playing time allocated to the programs;
a26) expressing the shares of playing time allocated to the programs such that the numerator of each share of total playing time allocated to the program is equal to said total duration multiplier coefficient;
a27) calculating a minimum total playing duration of the playlist that allows compliance with the share of total playing time allocated to each program, as:
the least common multiple of the denominators of the shares of total playing time allocated to the programs multiplied by the minimum program durations that allow compliance with the share of total playing time allocated to each content item within the programs; dividing the result by
the total duration multiplier coefficient;
a28) calculating a minimum number of occurrences of playing each program that allows compliance with the share of playing time allocated to the program, as:
the minimum total playing duration of the playlist that allows compliance with the share of total playing time allocated to each content item, multiplied by the total duration multiplier coefficient; dividing the result by
the denominator of the share of total playing time allocated to the program multiplied by the minimum program duration that allows compliance with the share of total playing time allocated to each content item within the program.

7. The method according to claim 2, wherein a3) reducing the number of occurrences of at least one content item comprises dividing the total number of occurrences of each content item by a same divisor, while approximating the total numbers of occurrences of content items which are not divisible by the divisor.

8. The method according to claim 2, wherein the step of reducing the number of occurrences of at least one content item is implemented only if a set of conditions is met, said set of conditions comprising at least one of the following conditions:
the sum of the minimum number of occurrences of each content item that allows compliance with the share of total playing time allocated to each content item is greater than a threshold number of occurrences;
the minimum duration of the list that allows compliance with the share of total playing time allocated to each content item is greater than a threshold duration.

9. The method according to claim 8, wherein:
the content item identifiers are distributed by programs, and:
each content item identifier is associated with a share of playing time allocated to the content item within the program;
each program is associated with a share of total playing time allocated to the program.
a3) reducing the number of occurrences of at least one content item comprises:
deleting at least one of the programs in order to meet said set of conditions;
calculating a minimum number of occurrences of playing each content item that allows compliance with the share of total playing time allocated to each content item without taking into account the at least one deleted program;
determining a divisor of the duration of the playlist thus obtained;
replacing said at least one of the deleted programs with an approximation of the division of the total number of occurrences of the program's content items by the divisor.

10. The method according to claim 2, wherein a3) reducing the number of occurrences of at least one content item comprises iteratively incrementing or decrementing the total counts of the content items, from the longest to the shortest content item, in order to reduce a remainder of a Euclidean division of the total counts of the content items by a divisor.

11. The method according to claim 1, further comprising:
b) said at least one server-generates, for each digital display device, a loading manifest comprising at least the loading addresses of the digital content items;
c) the digital display devices update the playlists and loading manifests, said update comprising:
c₁) each digital display device polls said at least one server at predetermined intervals, in order to determine whether said at least one server has a new playlist and/or a new loading manifest corresponding to said digital display device;
c₂) if so, said new playlist and/or said new loading manifest is loaded onto the digital display device;
c₃) if a new loading manifest has been loaded from the server, said digital display device determines which new digital content item(s) are referenced in said loading manifest;
c₄) and said digital display device downloads said new digital content item(s) from the address(es) indicated in the new loading manifest;
d) each digital display device reads the digital content items corresponding to a playlist in effect for this digital display device and displays these digital content items on a digital screen belonging to said digital display device.

12. The Digital display server adapted to control digital display devices, said server being adapted to implement the method according to claim 1.

13. A Computer program comprising instructions for implementing the method according to claim 1 when this program is executed by a processor.

14. A non-transitory computer-playable storage medium on which is stored a program for implementing the method according to claim 1 when this program is executed by a processor.
